(19) United States
(12) Patent Application Publication
(10) Pub. No.: US 2009/0305001 A1
(43) Pub. Date: Dec. 10, 2009

(54) HOUSING FOR ELECTRONIC DEVICE AND METHOD FOR MAKING THE HOUSING

(75) Inventors: CHE-YUAN HSU, Shindian (TW); CHENG-WEN SU, Shindian (TW); GANG HUANG, Shenzhen City (CN); YAN-MIN WANG, Shenzhen City (CN); QIANG WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/260,887

(22) Filed: Oct. 29, 2008

(30) Foreign Application Priority Data
Jun. 6, 2008 (CN) 200810302054.8

(51) Int. Cl. B32B 1/00; B28B 19/00

(52) U.S. Cl. 428/174; 264/269

(57) ABSTRACT

A housing (20) for use in a portable electronic device, includes a base (24) and a decorative film (22). The decorative film (22) is integrally molded with the base (24). The decorative film (22) includes a surface (221) separated from the base (24). The decorative film (22) is plastically deformed to form a three-dimensional pattern (222) on the surface (221).

### BACKGROUND

1. Field of the Invention

The present embodiment relates to housings for electronic devices, and a method for making the housings.

2. Description of Related Art

Portable electronic devices (such as mobile telephones and electronic notebooks) are in widespread use. The external appearance of the housing of the portable electronic device has become a key factor for attracting consumers.

The external appearance of the housing can usually be made by In-Mold Labeling (IML). A film with predetermined patterns, text, or pictures is placed in the die and directly molded to a housing molded within the die. However, because the die walls and the film typically used in In-Mold labeling are smooth, the final labeled housing will have flat, non-textured surfaces. Therefore, the surfaces of the labeled housing have not had three-dimensional (e.g. raised surfaces/textured) external appearances.

Therefore, there is room for improvement within the art.

### BRIEF DESCRIPTION OF THE DRAWINGS

Many aspects of the exemplary housing for electronic device and a method for making the housing can be better understood with reference to the following drawings. These drawings are not necessarily drawn to scale, the emphasis instead being placed upon clearly illustrating the principles of the present housing and method. Moreover, in the drawings like reference numerals designate corresponding parts throughout the several views. Wherever possible, the same reference numbers are used throughout the drawings to refer to the same or like elements of an embodiment.

FIG. 1 is a schematic and partially cut-away view of a housing in accordance with an exemplary embodiment.

FIG. 2 is a schematic view of a film for making the housing shown in FIG. 1.

FIG. 3 is a schematic view of a mold for making the housing shown in FIG. 1, showing one aspect.

FIG. 4 is a schematic view of the mold in FIG. 3, showing another aspect.

FIG. 5 is a schematic view when the film in FIG. 2 disposed within an upper mold in FIG. 3.

FIG. 6 is a schematic view of the mold shown in FIG. 4 during molding.

FIG. 7 is a cross section view of the mold shown in FIG. 6.

### DETAILED DESCRIPTION OF THE EXEMPLARY EMBODIMENTS

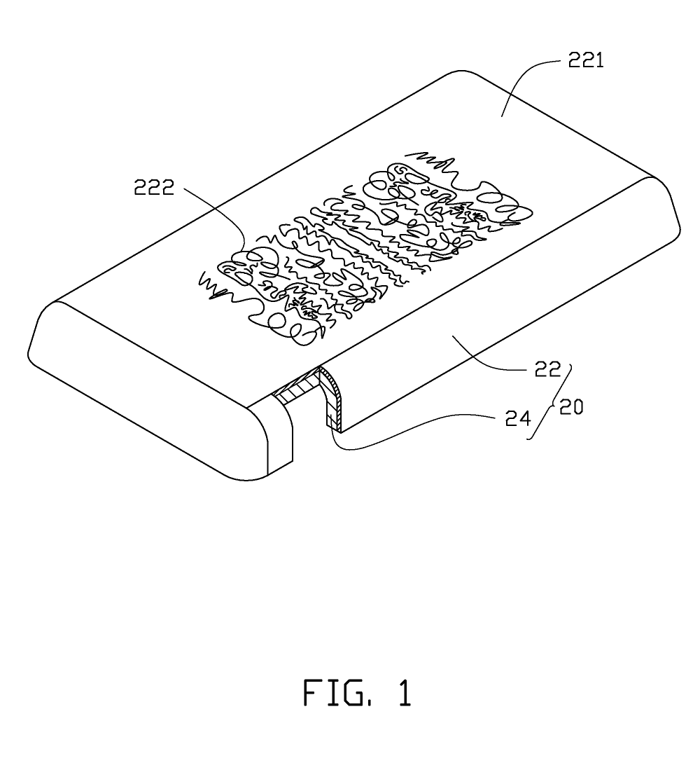

FIG. 1 shows an exemplary molded housing 20 including a base 24 integrally formed with a decorative film 22.

The decorative film 22 may be made of e.g., polycarbonate (PC), or other thermoplastic materials including polymethyl methacrylate and polystyrene. The decorative film 22 includes a surface 221. The decorative film 22 may be plastically deformed to form a three-dimensional pattern (e.g. raised or textured) 222 on the surface 221.

The base 24 may be made of a thermoplastic material chosen from the group consisting of polycarbonate, polymethyl methacrylate, polystyrene, and any combination thereof. The base 24 may also be made of silica gel.

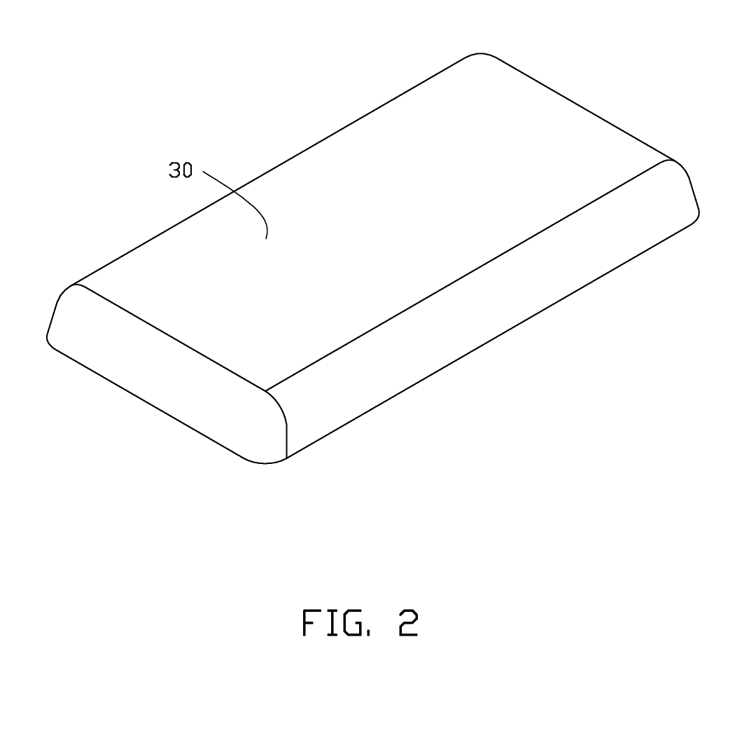

A method of making the molded housing 20 will now be described. Referring to FIG. 2, a film 30 is provided. The film 30 may be a polycarbonate thin film.

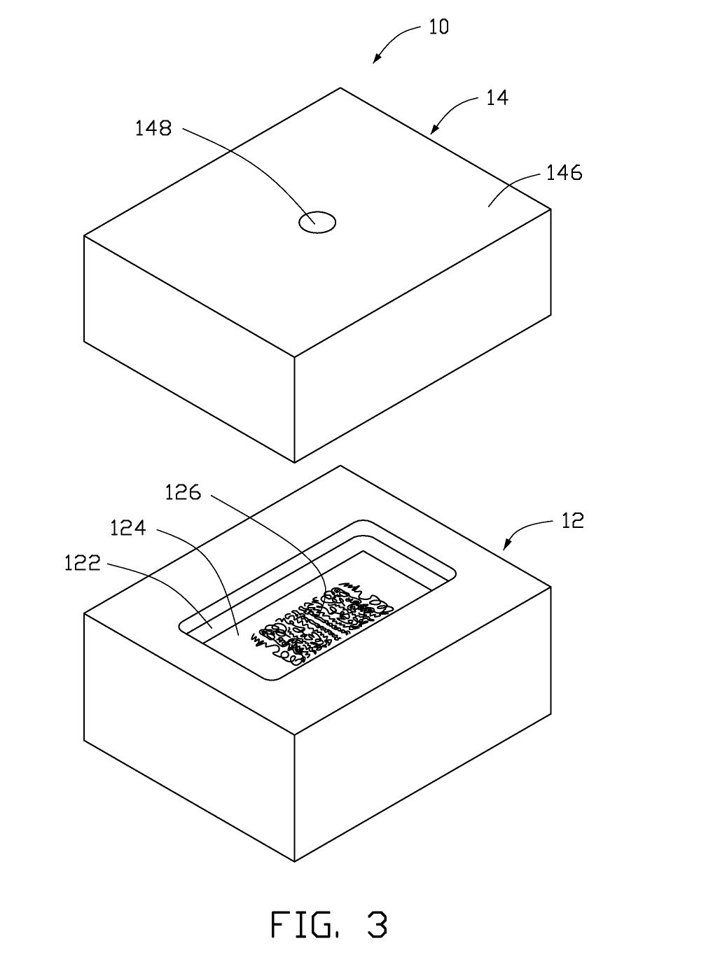

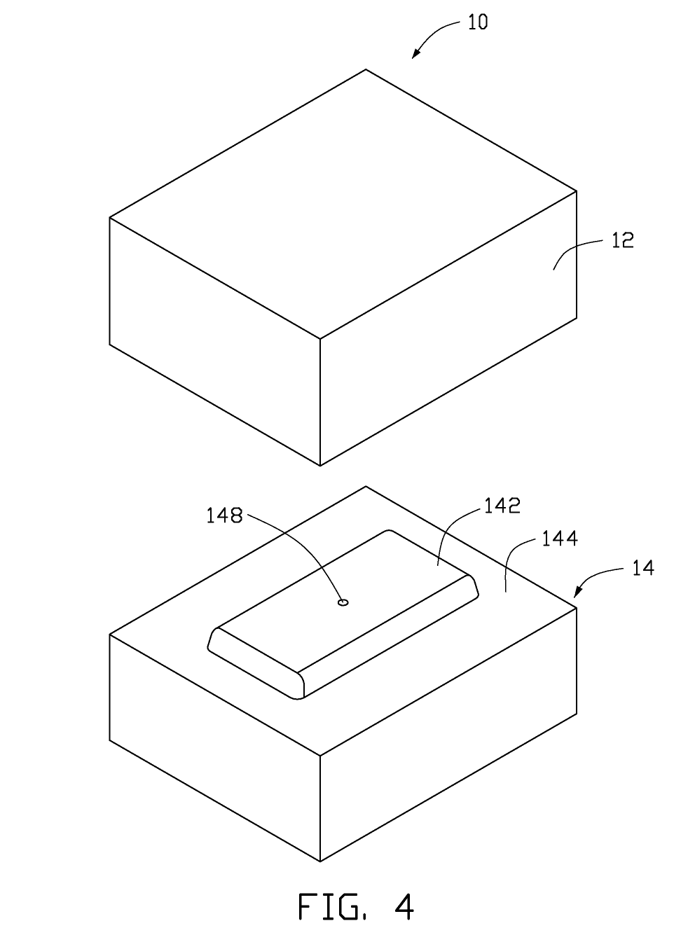

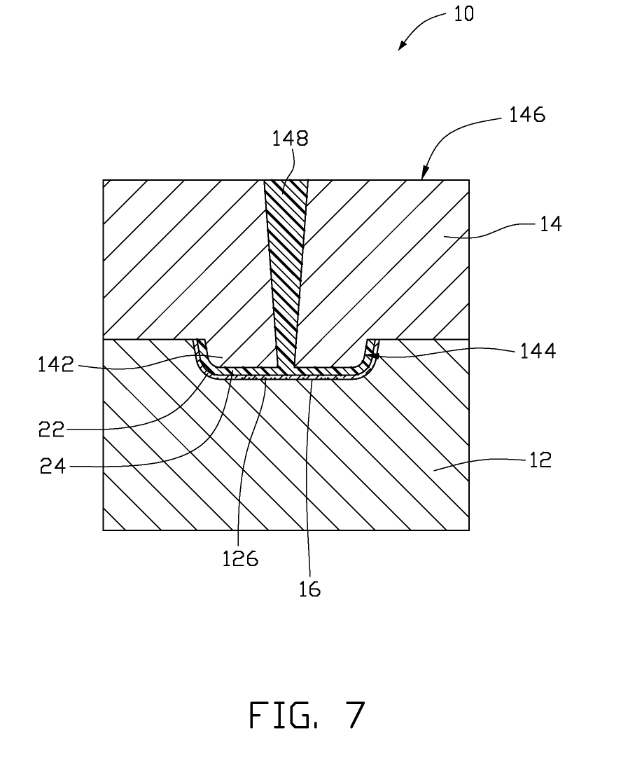

FIGS. 3 and 4 show a mold 10. The mold 10 includes an upper mold 12 and a lower mold 14 for engaging with the upper mold 12. The upper mold 12 defines a recessed portion 122 and a molding wall 124 at the bottom of the recessed portion 122. The molding wall 124 has a three-dimensional (e.g. raised or textured) pattern portion 126 defined at a central portion corresponding to the desired final pattern 222. The lower mold 14 has a mold core 142 corresponding to the recessed portion 122. The lower mold 14 includes a first mold surface 144 facing the upper mold 12 and a second mold surface 146 opposite to the first surface 144. The lower mold 14 defines a channel 148 (shown in FIG. 7) communicating with the molding cavity 16 and penetrating the mold core 142.

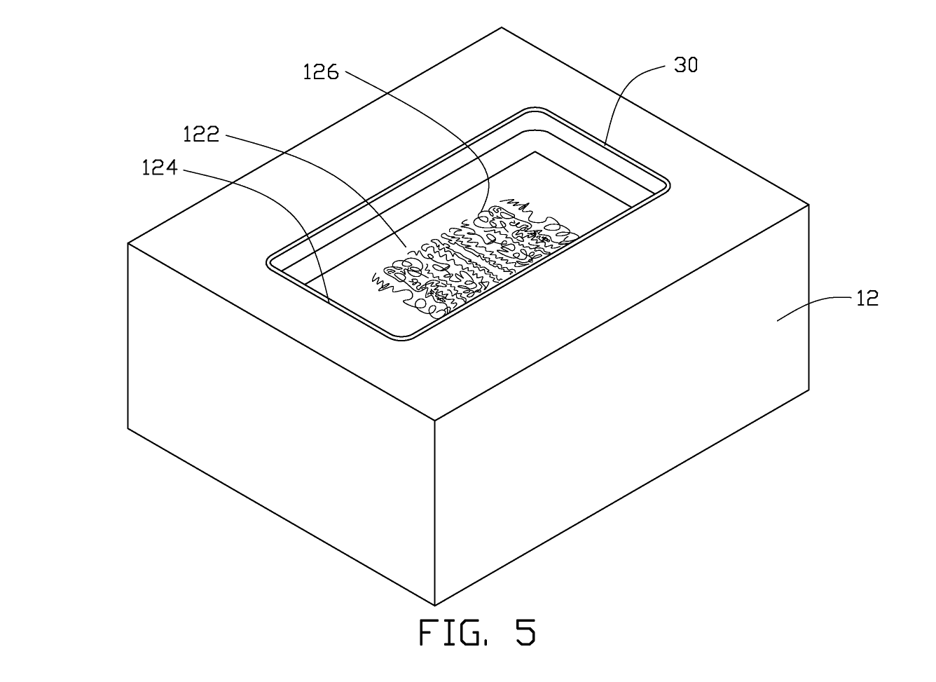

Referring to FIG. 5, the film 30 is positioned on and attached to the molding wall 124 within the recessed portion 122.

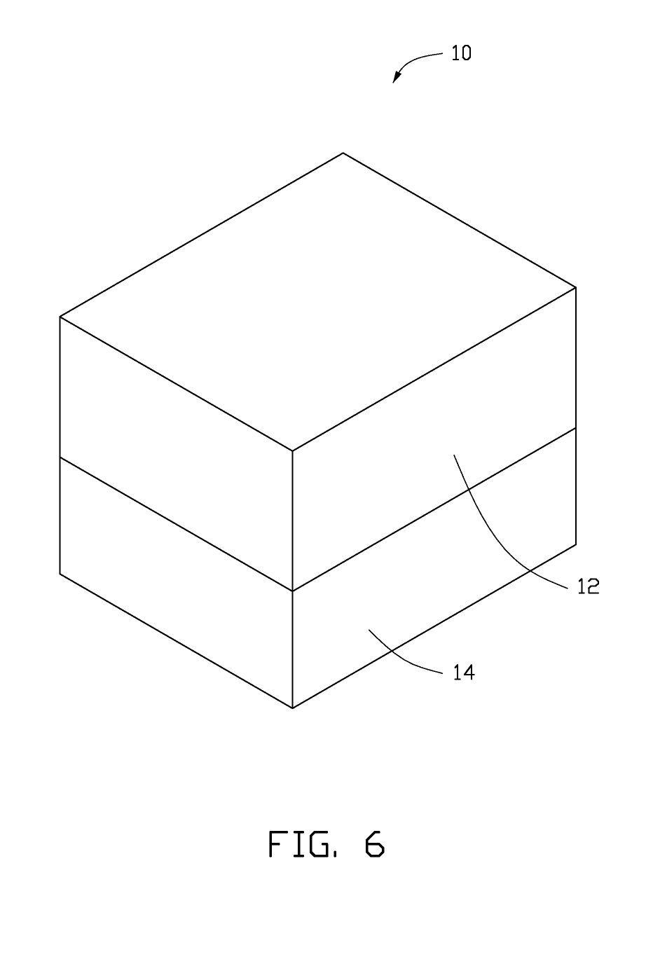

Referring to FIGS. 6 and 7, the molding cavity 16 is defined between the recessed portion 122 and the mold core 142. Molten plastic or silica gel is injected into the molding cavity 16 through the channel 148, to form the base 24. During this stage, the injected materials generate a pressure to securely attach the film 30 to the molding wall 124. The film 30 is heated and then softened, thereby plastically deforming to form the pattern 222 on the film. Thus, the film 30 is converted/molded to the decorative film 22. As such, the housing 20 is formed in the mold 10. The molten plastic may be transparent plastic material chosen from the group consisting of polycarbonate, polymethyl methacrylate, polystyrene, and any desired combination thereof.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A housing for use in a portable electronic device, comprising:
a base; and
a decorative film integrally molded with the base, the decorative film including a surface, and the decorative film plastically deformed to form a three-dimensional pattern on the surface.

2. The housing as claimed in claim 1, wherein the decorative film is made of thermoplastic material.

3. The housing as claimed in claim 2, wherein the thermoplastic material is chosen from the group of polycarbonate, polymethyl methacrylate, polystyrene.

4. The housing as claimed in claim 1, wherein the base is made of thermoplastic material.

5. The housing as claimed in claim 4, wherein the thermoplastic material is chosen from the group of polycarbonate, polymethyl methacrylate, polystyrene

6. A method for making a housing, comprising steps of:
providing a film;
providing a mold including an upper mold and a lower mold, the upper mold defining a recessed portion and a molding wall formed in the recessed portion, the molding wall having a three-dimensional pattern portion formed thereon, the lower mold having a mold core;
attaching the film to the molding wall and in the recessed portion;
closing the mold, a molding cavity being defined between the recessed portion and the mold core.;
injecting molten plastic into the molding cavity to form a base, and the base attached to the film;
wherein the molten plastic generates a pressure to tightly attach the film on the molding wall; and
heating and plastically deforming the film to form a three-dimensional pattern corresponding to the three-dimensional pattern portion.

7. The method as claimed in claim 6, wherein the decorative film is made of thermoplastic material.

8. The method as claimed in claim 7, wherein the thermoplastic material is chosen from the group of polycarbonate, polymethyl methacrylate, polystyrene.

9. The method as claimed in claim 6, wherein the base is made of thermoplastic material.

10. The method as claimed in claim 9, wherein the thermoplastic material is chosen from the group of polycarbonate, polymethyl methacrylate, polystyrene
